(19) United States
(12) Patent Application Publication
(10) Pub. No.: US 2007/0237613 A1
(43) Pub. Date: Oct. 11, 2007

(54) VEHICLE STORAGE DEVICE

(76) Inventor: James Randers, Minneapolis, MN (US)

Correspondence Address: GRAY, PLANT, MOOTY, MOOTY & BENNETT, P.A., P.O. BOX 2906, MINNEAPOLIS, MN, 55402-0906, US

(21) Appl. No.: 11/696,749

(22) Filed: Apr. 5, 2007

Related U.S. Application Data
(60) Provisional application No. 60/744,519, filed on Apr. 10, 2006.

(51) Int. Cl. B60B 29/00

(52) U.S. Cl. 414/426; 414/430; 280/79.11

(57) ABSTRACT

A vehicle storage device including a platform, a plurality of wheels, at least one cover support member, and cover. The platform has a guide and at least one anchor attached thereto. The guide and the at least one anchor are used for attaching a vehicle to the platform. The plurality of wheels attached to the platform to support the platform above a ground surface. The at least one cover support member attached to the platform. The cover that extends over the at least one cover support member for substantially enclosing an upper surface of the platform.

### REFERENCE TO RELATED APPLICATION

This application claims priority to U.S. Applic. No. 60/744,519, filed Apr. 10, 2006, the content of which is incorporated herein by reference.

### FIELD OF THE INVENTION

The invention relates to storage devices, and more particularly, to storage devices adapted to store vehicles such as motorcycles, bicycles, dirt bikes and the like.

### BACKGROUND OF THE INVENTION

Motorcycles, bicycles, ATVs, dirt bikes and the like are popular vehicles for transportation and/or recreation activities. For example, events such as the Sturgis Rally annually draw thousands of motorcycle enthusiasts to South Dakota. Motorcycle riders and ATV users are located across the country, both in areas where the vehicles can be used year round and in areas where the vehicles are practical only during portions of the year. Additionally, riders who participate in off road races and other competitions using ATVs, bicycles and/or dirt bikes may only use their vehicles during a selected portion of the year. As such, there exists a need to conveniently store motorcycles, dirt bikes and other vehicles when the vehicles are not in use.

### SUMMARY OF THE INVENTION

Improved storage devices for storing vehicles such as, for example, motorcycles comprise a body portion having a platform suitable for supporting a desired vehicle and at least one securing element operably coupled to the platform to secure a vehicle to the platform. The securing element can be any fastening element suitable for use in automotive applications including, for example, brackets, ratchet tie downs, rubber or elastic tie downs, indentations or grooves in the platform adapted to receive a wheel, and combinations thereof. Generally, the body portion can be provided with a plurality of casters or wheels, which allows a user to easily roll the storage devices around a garage or other storage area.

The body portion of the storage device can be formed from any appropriate material such as, for example, metals, metal alloys, wood, polymers and combinations thereof. In embodiments where the body portion is formed from a metal, the body portion can comprise a powder coated finish and a platform having a diamond plate aluminum top surface.

A dehumidifier can be operably coupled to the body portion of the storage devices, which can reduce or eliminate moisture during storage and/or transportation of the vehicle. The storage devices may also be provided with an outdoor UL box for charging a battery.

In some embodiments, the storage device can include structure which facilitates attaching a cover to the storage device to isolate the vehicle from the ambient atmosphere. The cover can protect the vehicle from dust and chemicals during storage, and can also conceal the vehicle such that the vehicle will not be apparent to individuals passing by an open garage or storage area.

The storage devices can be designed to accommodate a single motorcycle or bike, or can be designed to store a plurality of motorcycles. In some embodiments, the storage devices can be designed to accommodate bikes up to 48 inches wide, 63 inches high and 106 inches long.

Additionally, the storage devices can include structure that facilitates engagement with a fork lift and/or pallet jack, which allows a user elevate the storage device such that the storage devices can be used for shipping applications.

In one aspect, the invention pertains to a storage device for a vehicle comprising a body portion having a platform adapted to receive a vehicle, a bracket operably coupled to the platform and a plurality of casters operably coupled to the body portion. In these embodiments, the bracket can include a first horizontal portion, a second horizontal portion, and a C-shaped tire engaging portion operable coupled to the first horizontal portion and the second horizontal portion, wherein the C-shaped tire engagement portion is adapted to receive and secure the front tire of a vehicle.

In another aspect, the invention pertains to a storage device for a two-wheeled vehicle comprising a body portion having a platform adapted to receive a two-wheeled vehicle, means for securing the vehicle to the platform operably coupled to the platform and a plurality of casters operably coupled to the body portion.

### BRIEF DESCRIPTION OF THE FIGURES

FIG. 1 is a perspective view of a metal storage device having a motorcycle secured to the storage device.

FIG. 2 is a front perspective view of the storage device of FIG. 1 with a plurality of cover support members operably coupled to the body portion.

FIG. 3 is a front perspective view of the storage device of FIG. 2 with a cover substantially attached to the plurality of support members.

FIG. 4 is a perspective view of the storage device of FIG. 2 with a cover attached to the plurality of support members to isolate the motorcycle from the ambient atmosphere.

FIG. 5 is a perspective view of a storage device showing a bracket adapted to secure a motorcycle to the storage device.

FIG. 6 is perspective view of a wood storage device having a motorcycle secured to the storage device.

FIG. 7 is a perspective view of the storage device of FIG. 6 with a plurality of cover support members operably coupled to the body portion.

FIG. 8 is a back perspective view of the storage device of FIG. 7 with a cover partially attached to the plurality of supporting members.

FIG. 9 is a back perspective view of the storage device of FIG. 7 with a cover substantially attached to the plurality of supporting members.

FIG. 10 is a back perspective view of the storage device of FIG. 7 with a cover attached to the plurality of supporting members to isolate the motorcycle from the ambient atmosphere.

### DETAILED DESCRIPTION OF THE PRESENT INVENTION

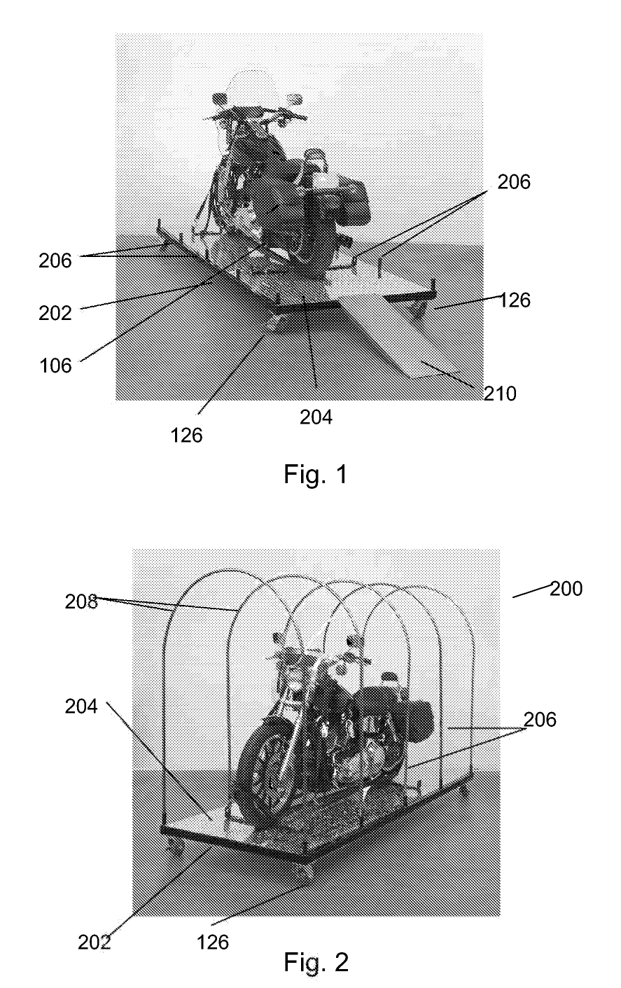

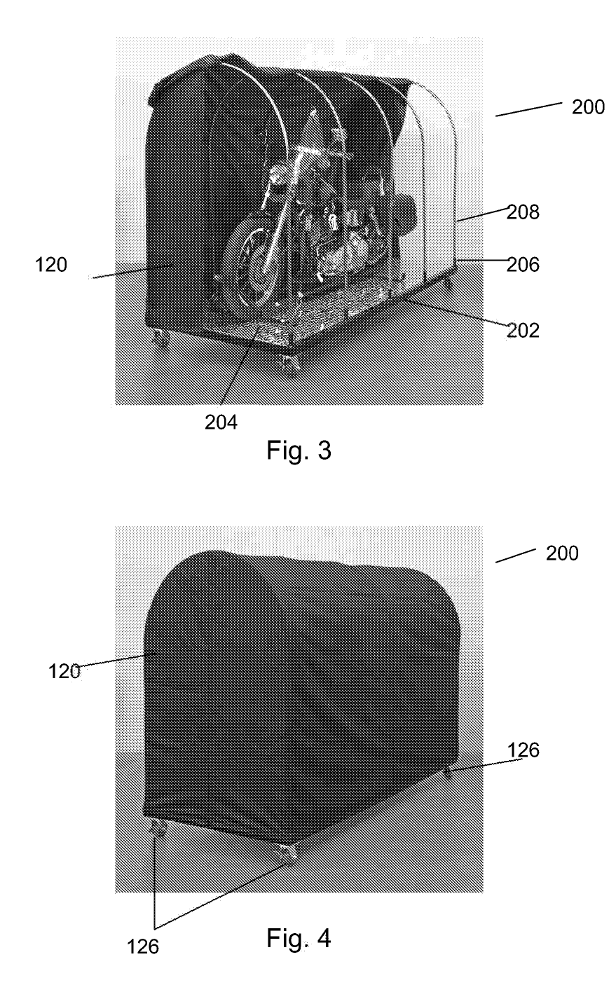

Referring to FIGS. 1-5, an embodiment of a storage device is depicted. In this embodiment, storage device 200 can comprise a metal body portion 202 having a metal platform 204. In some embodiments, body portion 202 can comprise a powder coated finish and platform 204 can comprise a diamond plate aluminum top surface. In one configuration, platform 204 can comprise aluminum. Additionally, body portion 202 can be provided with a plurality of cover support pegs 206 that are adapted to engage with cover support members 208. As described above, storage device 200 can include bracket 106, a plurality of casters 126 and a cover 120.

Ramp 210 can be provided to facilitate positioning of a vehicle onto the top surface of platform 204. The ramp 210 may be fabricated from Diamond Plate Aluminum and may have the following dimensions— 3/16 of and inch thick, 12 inches thick and 48 inches long.

Body portion 202 and ramp 210 can define holes or openings, which allows ramp 210 to be attached to body portion 202 by pins, screws or the like. Generally, ramp 204 can be formed from any appropriate materials including, for example, metals, metal alloys, wood, polymers and combinations thereof.

During use of the of the storage devices of the present invention, a vehicle such as, for example, a motorcycle can be positioned on the platform such that the tire engaging portion of the bracket contacts the front wheel of the motorcycle. Optional tie downs can then be attached to the motorcycle and the bracket to further secure the motorcycle on the platform. The cover support members can then be operably coupled to the storage device, and the cover can attached to isolate the motorcycle from the ambient atmosphere.

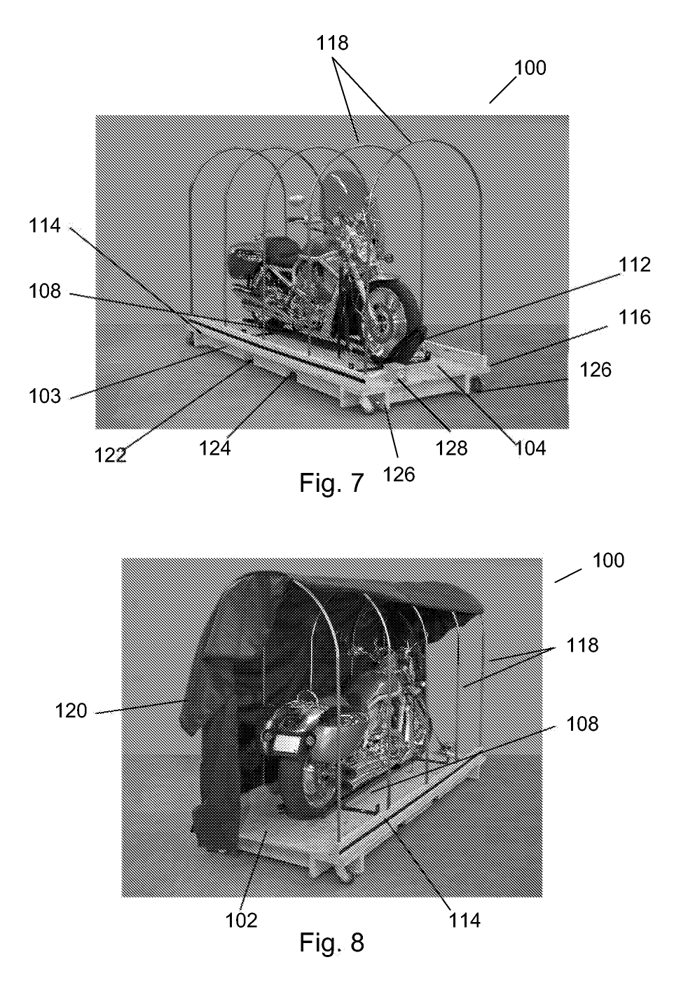

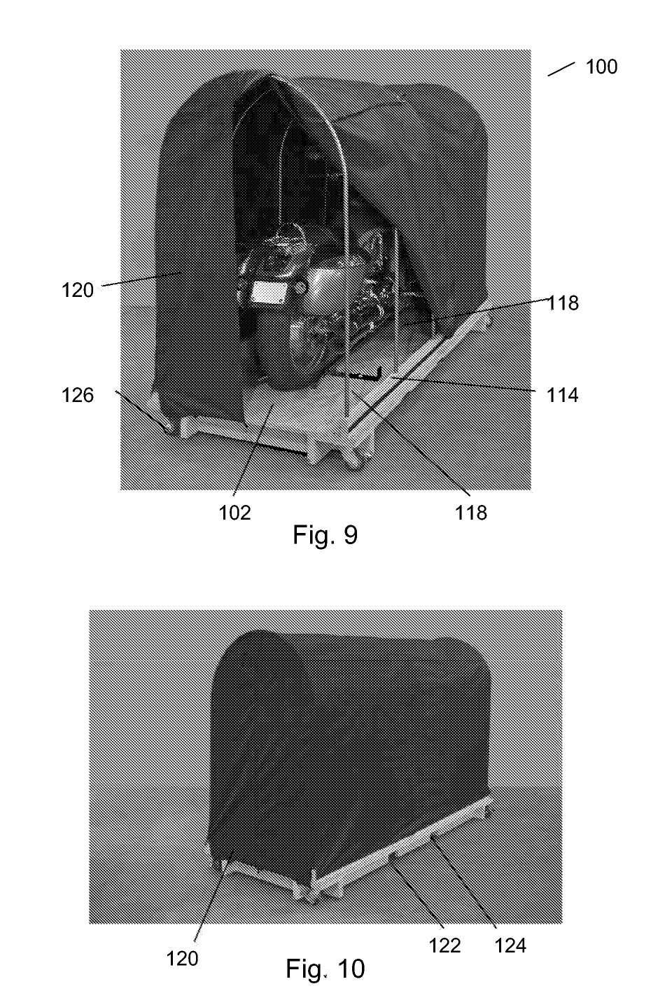

With respect to FIGS. 6-10, a wood vehicle storage device 100 is depicted comprising body portion 102 having a base portion 103 connected to platform 104, which is adapted to receive one or more vehicles such as, for example, motorcycles, dirt bikes, ATVs, bicycles, and the like, and combinations thereof Generally, one or more means for securing a vehicle are provided to platform 104. In some embodiments, the means for securing can include bracket 106. In one embodiment, bracket 106 can include a first horizontal portion 108, a second horizontal portion 110 and a tire engaging portion 112 operably coupled to first horizontal portion 108 and second horizontal portion 110.

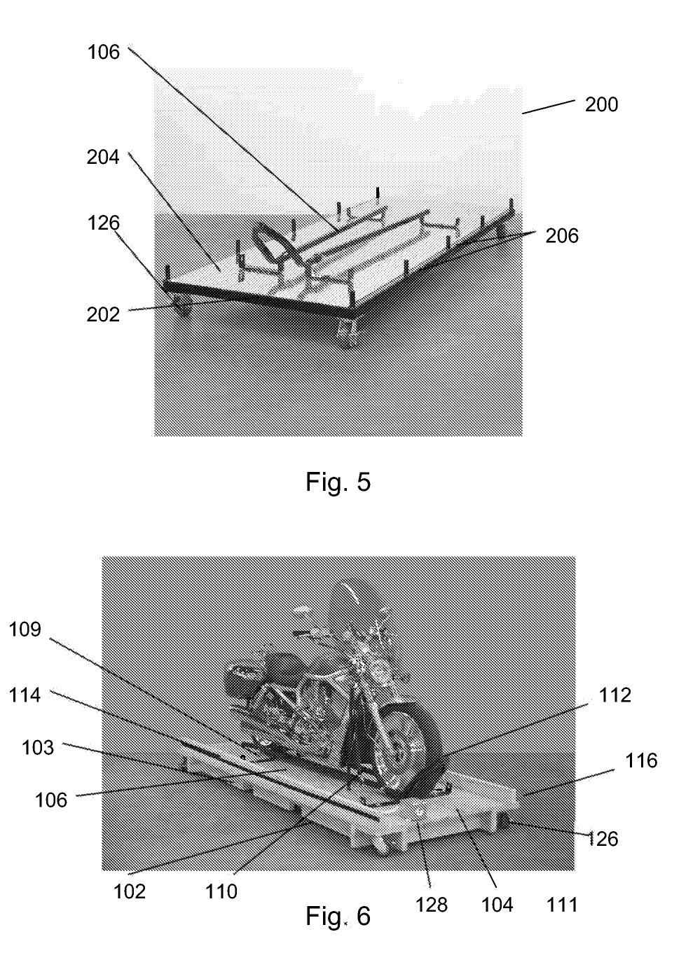

As depicted in FIG. 6, first horizontal portion 108 and second horizontal portion 110 can be rails that are spaced such that a two wheeled vehicle can fit between first horizontal portion 108 and second horizontal portion 110. Referring to FIG. 5, first horizontal portion 108 and second horizontal portion 110 can be connected to platform 104 such that the space between portion 108 and portion 110 becomes smaller as the portions approach tire engagement portion 112, which facilitates engagement of portions 108 and 110 with the front tire of a motorcycle or other vehicle. Tire engaging portion 112 can be a generally C-shaped element that is adapted to fit around the front tire of a two wheeled vehicle such as a motorcycle to prevent forward motion of the vehicle during storage.

First and second horizontal portions 108, 110 of bracket 106 can be elevated above the top surface of platform 104 by elements 109, 111. As depicted in FIG. 6, elements 109, 111 can include a vertical portion defining an opening that can engage with the hook portion of a tie down to further secure a vehicle to storage device 100.

In some embodiments, body portion can include 102 can include side rails 114, 116 connected to platform 104. Side rails 114, 116 can each define a plurality of openings adapted to receive cover support members 118. Cover support members 118 provide support for cover 120, which facilitates isolating a vehicle secured to platform 104 from the ambient atmosphere. Cover support members 118 can be formed from any appropriate material such as metals, metal alloys, polymers and combinations thereof.

Cover 120 can be a nylon cover adapted to isolate a vehicle secured to platform 104 from the ambient atmosphere. Cover 120 can include fastening elements such as, for example, hook and loop fasteners (VELCRO), snaps, pins or the like that can operably couple with corresponding fastener elements on body portion 102 to secure cover 120 to body portion 102. Cover 120 can also comprise a zipper at each end of cover 120, which allows a user to access a vehicle when cover 120 is attached to cover support members 118.

Base portion 103 can define openings 122, 124 which can be adapted to engage with a fork lift or pallet jack, which facilitates lifting and/or moving storage device 100, and allows storage device 100 to be used in shipping applications. Additionally, a plurality of casters 126 can be operably coupled to body portion 102 to allow a user to roll storage device around a garage, showroom or other storage area.

In some embodiments, one or more dehumidifiers can be operably coupled to platform to reduce or eliminate moisture during storage of the vehicle. In one embodiment, the dehumidifier can comprise a Goldenrod dehumidifier. Platform 104 can also be provided with battery charging element 128 such as, for example, an outdoor UL box.

The embodiments above are intended to be illustrative and not limiting. Additional embodiments are within the claims. Although the present invention has been described with reference to particular embodiments, workers skilled in the art will recognize that additional changes may be made in form and detail without departing from the spirit and scope of the invention.

1. A vehicle storage device comprising:
a platform having a guide and at least one anchor attached thereto, wherein the guide and the at least one anchor are used for attaching a vehicle to the platform;
a plurality of wheels attached to the platform to support the platform above a ground surface;
at least one cover support member attached to the platform; and
a cover that extends over the at least one cover support member for substantially enclosing an upper surface of the platform.

2. The vehicle storage device of claim 1, wherein the platform is fabricated from wood, metal, plastic or combinations thereof.

3. The vehicle storage device of claim 1, wherein the platform has a traction enhancement surface on an upper surface thereof.

4. The vehicle storage device of claim 1, wherein the guide has a bottom panel and a pair of side panels extending therefrom, and wherein a distance between the side panels is approximately the same as a width of a motorcycle tire.

5. The vehicle storage device of claim 4, wherein the guide further comprises a stop extending therefrom, and wherein the stop engages the motorcycle tire.

6. The vehicle storage device of claim 1, wherein the guide comprises a pair of elongated guide members mounted to the platform in a spaced-apart configuration.

7. The vehicle storage device of claim 1, wherein the guide comprises a pair of elongated guide members mounted to the platform so that a first spacing between a first end of the elongated guide members is closer than a second spacing between a second end of the elongated guide members.

8. The vehicle storage device of claim 1, wherein the platform further comprises at least one forklift recess formed therein that is adapted to receive a fork extending from a forklift.

9. The vehicle storage device of claim 1, wherein the at least one cover support member has a U-shaped configuration.

10. The vehicle storage device of claim 1, wherein the at least one cover support member comprises at least three cover support members.

11. The vehicle storage device of claim 1, and further comprising a plurality of support pegs extending from the platform, wherein each of the support pegs are adapted to receive an end of one of the cover support members.

12. The vehicle storage device of claim 1, wherein the cover is operably coupled to the platform to isolate a vehicle placed on the platform.

13. The vehicle storage device of claim 1, and further comprising a ramp that is capable of engaging an edge of the platform to facilitate moving a vehicle on to and off of the platform.

14. The vehicle storage device of claim 13, wherein the platform includes at least one aperture formed therein that is adapted for use in attaching the ramp to the platform with an attachment mechanism.

15. A method of storing and transporting a motorcycle comprising:
providing a vehicle storage device comprising a platform having a guide, at least one anchor attached thereto and a plurality of wheels attached thereto, wherein the plurality of wheels support the platform above a ground surface;
positioning the motorcycle on the platform using the guide;
attaching the motorcycle to the platform by extending a strap around the motorcycle and attaching the strap to the at least one anchor;
attaching at least one cover support member to the platform; and
extending a cover over the at least one cover support member to substantially enclose an upper surface of the platform.

16. The method of claim 15, and further comprising placing a traction enhancement surface on an upper surface of the platform.

17. The method of claim 15, wherein the guide comprises a pair of elongated guide members mounted to the platform so that a first spacing between a first end of the elongated guide members is closer than a second spacing between a second end of the elongated guide members.

18. The method of claim 1, and further comprising attaching the at least one cover support member to the platform using a plurality of support pegs extending from the platform.

19. The method of claim 1, and further comprising operably coupling the cover to the platform to isolate the motorcycle from environment outside of the cover.

20. The method of claim 1, and further comprising moving the motorcycle on to the platform using a ramp that engages an edge of the platform.
